(19) United States
(12) Patent Application Publication
(10) Pub. No.: US 2026/0259340 A1
(43) Pub. Date: Sep. 3, 2026

(54) MONITORING SYSTEM FOR UNDERGROUND CARBON DIOXIDE STORAGE USING PERMANENT SUBSEA ACOUSTIC SOURCE AND SUBSEA OPTICAL CABLE

(71) Applicant: KOREA INSTITUTE OF GEOSCIENCE AND MINERAL RESOURCES, Daejeon (KR)

(72) Inventors: Byoungjoon YOON, Daejeon (KR); Kwon Gyu PARK, Sejong-si (KR); Snons CHEONG, Sejong-si (KR); Yong Chan PARK, Sejong-si (KR); Chang Hyun LEE, Daejeon (KR)

(21) Appl. No.: 19/542,798

(22) Filed: Feb. 18, 2026

(30) Foreign Application Priority Data
Feb. 28, 2025 (KR) 10-2025-0026584

(51) Int. Cl. G01V 1/38; B65G 5/00; G01V 8/16; G01V 11/00

(52) U.S. Cl. CPC G01V 1/3808; B65G 5/00; G01V 1/3852; G01V 8/16; G01V 11/00; G01V 2210/1214; G01V 2210/1297; G01V 2210/1427

(57) ABSTRACT

The present disclosure relates to a carbon dioxide monitoring system using a subsea optical cable. The system includes an optical cable laid on a seafloor of a carbon dioxide storage site, a fixed continuous seismic source configured to generate a sweep signal by applying continuous vibration at a fixed position, and a seismic receiver installed near the seismic source to directly receive the sweep signal. An interrogator irradiates the optical cable with laser light and receives backscattered-light signals from points along the optical cable to implement distributed acoustic sensing. A signal conversion unit converts the backscattered-light signals into impulse-response converted signals through sweep deconvolution. Thus, although exploration is performed using a continuous seismic source, signal processing enables acquisition of data equivalent to that obtained using an impulse-type seismic source. The system enables monitoring of reservoir conditions associated with carbon dioxide injection.

### CROSS-REFERENCE TO RELATED APPLICATION

This application claims priority to Korean Patent Application No. 10-2025-0026584 filed on Feb. 28, 2025 and all the benefits accruing therefrom under 35 U.S.C. § 119, the contents of which are incorporated by reference in their entirety.

### BACKGROUND

The present disclosure relates to a technology for underground storage of carbon dioxide, and more particularly, to a technology for continuously monitoring an injection state and behavior of carbon dioxide in a subsea carbon dioxide storage site using distributed acoustic measurement technology.

Carbon Capture and Storage (CCS) technology, which involves capturing carbon dioxide emitted from industrial sites and storing the captured carbon dioxide underground, particularly research on storing the carbon dioxide in subsea reservoirs, has been actively conducted.

In marine CCS technology, carbon dioxide is injected using developed gas fields, aquifers, or the like as reservoirs, but continuous monitoring of the storage state and behavior of carbon dioxide in the reservoir is required before, during, and after carbon dioxide injection.

In the related art, conventional seismic exploration technology is used for marine CCS exploration and monitoring. That is, while a streamer in which a plurality of seismic receivers (hydrophones) are mounted in a single row at regular intervals is towed by a survey vessel at sea, seismic waves are transmitted from the survey vessel and reflected waves returning from the subsea strata are received by the hydrophones. Marine seismic exploration is performed before and after carbon dioxide injection and at constant intervals and regularly to monitor changes in the reservoir conditions.

However, existing marine seismic exploration methods have many limitations.

First, in the existing marine seismic exploration, an exploration system consisting of a survey vessel, air guns, and a hydrophone streamer is operated, and there is a problem in that the monitoring processes and operations are very complicated and the costs are very high.

Therefore, periodic monitoring at short time intervals is difficult. For example, in the Sleipner project in Norway, monitoring is conducted only about twice a year. However, in order to inject carbon dioxide, continuous monitoring is required before, during, and after injection. Especially during carbon dioxide injection, since the state of the reservoir changes in real time, it is desirable to perform monitoring in real time. In addition, when monitoring is conducted by operating the survey vessel at intervals of several months, there are limitations in examining the changing patterns by performing monitoring under the same conditions and environment due to the fact that the climate, weather conditions, even the conditions for firing the air gun on the survey vessel, and the like all change.

In addition, existing marine seismic exploration uses explosive seismic sources with high energy, such as air guns, which may have negative impacts on marine ecosystems, especially marine mammals.

### SUMMARY

The present disclosure is intended to solve the above-mentioned problems, and an object of the present disclosure is to provide an underground carbon dioxide monitoring system that is capable of real-time monitoring of carbon dioxide behavior in a reservoir by deploying optical-fiber distributed sensors on the seabed and installing a seismic source in a fixed manner, and that is environmentally friendly and highly economical.

Other objects not mentioned in the present disclosure will be additionally considered within the scope to be easily inferred from the following detailed description and effects thereof.

An underground carbon dioxide monitoring system using a subsea optical cable according to the present disclosure includes an optical cable laid on a seafloor of a carbon dioxide subsea storage site, a fixed continuous seismic source configured to apply continuous vibration for a predetermined period of time at a fixed position in the subsea storage site to generate a sweep signal, a seismic receiver installed close to the fixed continuous seismic source and configured to directly receive the sweep signal that is not reflected by a stratum, an interrogator including a light source configured to irradiate the optical cable with laser light, a photodetector configured to receive a backscattered-light signal that is returned from each point of the optical cable by the laser light emitted from the light source, and a signal processing unit configured to process the backscattered light, and a signal conversion unit configured to convert the backscattered-light signal received from the interrogator into a waveform for exploration by an impulse-type seismic source and the seismic receiver.

According to the present disclosure, the signal conversion unit generates an impulse-response converted signal to be received using the impulse-type seismic source and the seismic receiver from the backscattered-light signal through sweep deconvolution processing of comparing the backscattered-light signal processed by a signal processing unit of the interrogator and the sweep signal received by the seismic receiver with each other.

In one example of the present disclosure, a strength reinforcement wire capable of withstanding tension may be secured together with the optical cable to prevent the optical cable from breaking when the optical cable is laid on the seafloor from a sea surface.

In one example of the present disclosure, the underground carbon dioxide monitoring system may further include a plurality of weights coupled to the strength reinforcement wire or the optical cable for the optical cable to be seated on the seafloor.

In one example of the present disclosure, the underground carbon dioxide monitoring system may further include a signal enhancement unit configured to generate a plurality of impulse-response converted signals by performing monitoring on the optical cable at time intervals, and then increase a signal-to-noise ratio by stacking the plurality of impulse-response converted signals.

In one example of the present disclosure, the underground carbon dioxide monitoring system may further include a time-lapse analysis unit configured to generate the impulse-response converted signals at different time points before and after carbon dioxide injection or during carbon dioxide injection, and then perform time-lapse analysis to derive differences between the impulse-response converted signals at respective time points.

In one example of the present disclosure, the time-lapse analysis unit may separate a signal in the form of a reflected wave from the impulse-response converted signals at different time points and identify a change in a reservoir.

In one example of the present disclosure, a borehole may be formed in the reservoir, a vertical optical cable disposed vertically on a wall surface of the borehole and connected to the interrogator may be installed, and the time-lapse analysis unit may separate a signal having an upward-sloping form from the impulse-response converted signals that are acquired and converted from the vertical optical cable at respective different time points and identify a change in the reservoir.

In one example of the present disclosure, the fixed continuous seismic source may be an offshore wind turbine, and for the optical cable, a communication optical cable that is pre-installed on the seafloor may be used.

### BRIEF DESCRIPTION OF THE DRAWINGS

Exemplary embodiments can be understood in more detail from the following description taken in conjunction with the accompanying drawings, in which:

FIG. 1 is a schematic diagram of an underground carbon dioxide monitoring system using a subsea optical cable according to an example of the present disclosure;

FIG. 2 is a view showing a state in which an optical cable is laid on the seabed and a situation in which vibration is applied to the optical cable from a fixed continuous seismic source;

FIG. 3 compares forms of signals received from a vertical optical cable (a) and a horizontal optical cable (b);

FIG. 4 is view for describing a process of laying an optical cable on the seafloor;

FIG. 5 is a diagram for describing sweep deconvolution processing;

FIG. 6 shows DAS data;

FIG. 7 shows a result of sweep deconvolution processing of DAS data;

FIG. 8 is a view for describing time-lapse analysis; and

FIG. 9 shows a result of Kirchhoff migration.

It is clarified that the attached drawings are illustrated as a reference for understanding the technical concept of the present disclosure, and the scope of the present disclosure is not limited by the drawings.

### DETAILED DESCRIPTION OF EMBODIMENTS

In describing the present disclosure, detailed descriptions related to well-known functions and matters obvious to a person skilled in the art will be ruled out when the functions and matters unnecessarily obscures the subject matters of the present disclosure.

The present disclosure is to monitor an injection state and behavior of carbon dioxide, which is a greenhouse gas, when the carbon dioxide is stored in a subsea reservoir. A reservoir state before carbon dioxide injection and a reservoir state after injection are monitored. In addition, the behavior of carbon dioxide is monitored during carbon dioxide injection.

Since the present disclosure enables real-time monitoring during a carbon dioxide injection process and provides a simple and economical monitoring method, there is an advantage in that the reservoir may be monitored at very frequent intervals. This is because in the present disclosure, distributed acoustic sensing (DAS) technology using optical fiber cables as a monitoring means is used.

Hereinafter, with reference to the accompanying drawings, an underground carbon dioxide monitoring system using a subsea optical cable according to an example of the present disclosure will be described in detail.

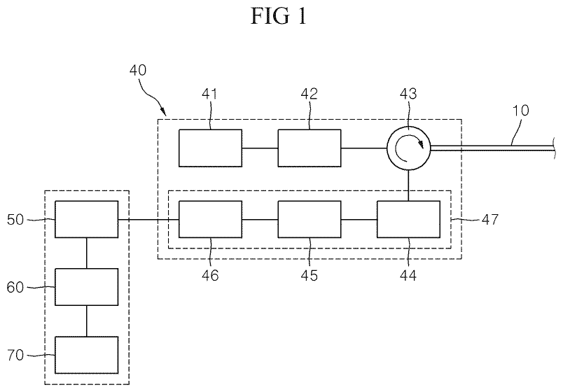

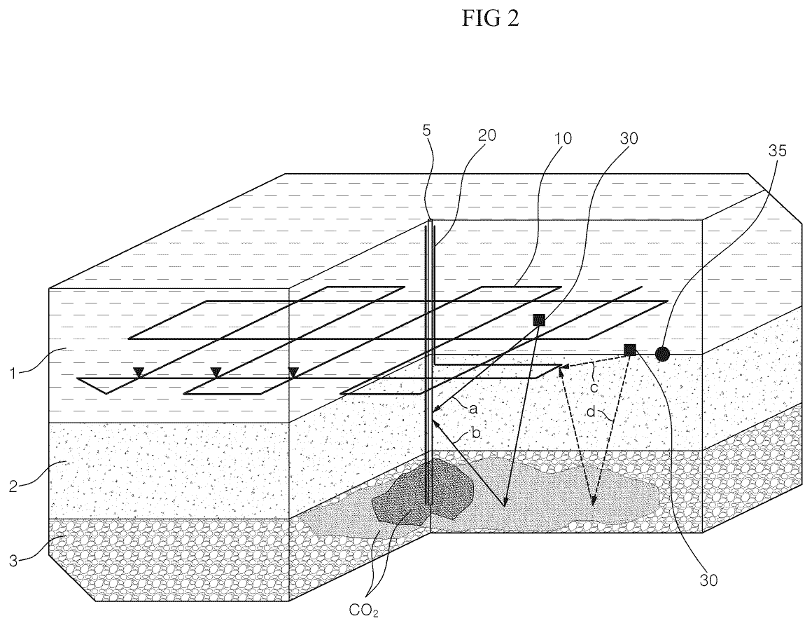

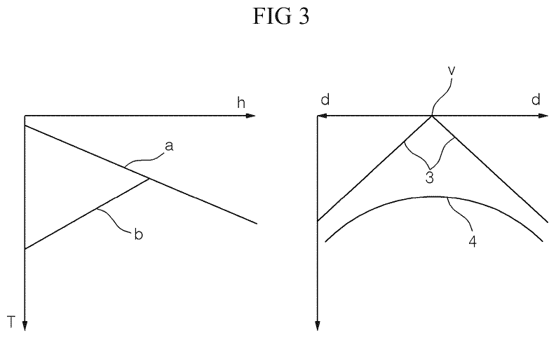

FIG. 1 is a schematic diagram of an underground carbon dioxide monitoring system using a subsea optical cable according to an example of the present disclosure, FIG. 2 is a view showing a state in which an optical cable is laid on the seabed and a situation in which vibration is applied to the optical cable from a fixed continuous seismic source, and FIG. 3 compares forms of signals received from a vertical optical cable (a) and a horizontal optical cable (b).

Referring to the drawing, an underground carbon dioxide monitoring system using a subsea optical cable according to an example of the present disclosure (hereinafter referred to as a “carbon dioxide monitoring system”) includes optical cables 10 and 20, a continuous seismic source 30, a seismic receiver 35, and an interrogator 40.

In the present disclosure, the optical cable basically uses a horizontal optical cable 10. The horizontal optical cable 10 is laid on the seafloor of a subsea reservoir. As shown in FIG. 2, it is desirable that the optical cable be laid in a matrix form, but the optical cable may also be laid in a linear form instead of the matrix form. When a subsea optical cable is separately laid for carbon dioxide monitoring, it is laid in the matrix form as shown in FIG. 2. However, there are cases where a communication optical cable is installed near a carbon dioxide storage site. In addition, since communication optical cables have spare lines that are not used for communication, existing communication optical cables may be utilized for carbon dioxide monitoring purposes. There is a significant economic advantage when existing communication optical cables are used.

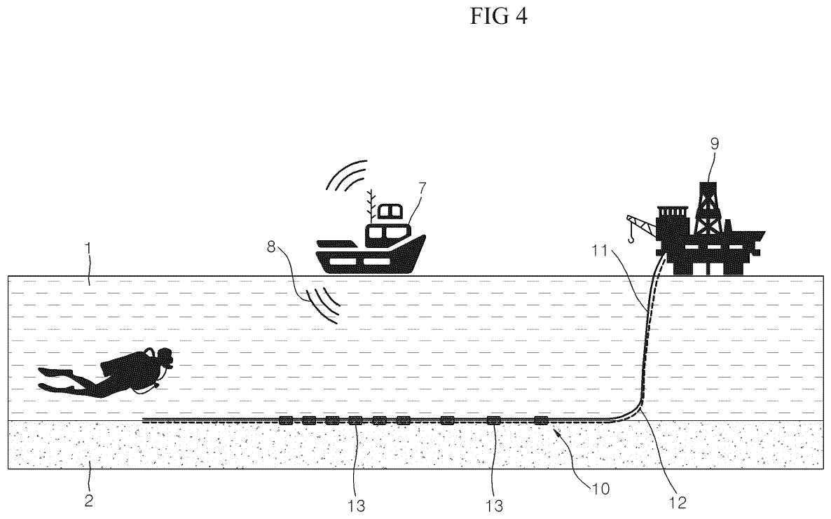

Meanwhile, when a horizontal subsea optical cable 10 is laid on the seafloor, a vessel is used. When the optical cable is wound around a winch of the vessel and the vessel moves along a set route while unwinding the optical cable, the cable is laid on the seafloor. The problem is that since the optical cable needs to be installed over long distances of several kilometers, the optical cable may break or be damaged by tension during a laying process. In order to solve this problem, in the present disclosure, as shown in FIG. 4, a strength reinforcement wire 12 is secured to the optical cable 10 in parallel. In the present example, the strength reinforcement wire 12 uses a steel wire capable of withstanding tension. The strength reinforcement wire and the optical cable are secured together by a separate connecting means (not shown). In addition, weights 13 are secured to the optical cable and the strength reinforcement wire at regular intervals. When the optical cable is pressed against the seafloor by the weights 13, the vibration to be transmitted to the ground is accurately applied, thereby improving the signal quality.

After the laying of the optical cable 10 is completed, information on the position and route of the laid optical cable may be confirmed using a side scan sonar 8 on a GPS-equipped vessel 7, and in shallow water areas, a diver may be used supplementarily.

In addition, in one example of the present disclosure, a vertical optical cable 20 may be additionally used in addition to a horizontal optical cable 10 laid on the seafloor. That is, the vertical optical cable 20 is used by being embedded longitudinally in an up-down direction in a wall of a borehole 5 for injecting carbon dioxide into a subsea reservoir 2.

The fixed continuous seismic source 30 is intended to apply continuous vibration to the reservoir 2 at a fixed position for a predetermined period of time. In general, in marine seismic exploration, it is common to apply vibration in the form of shock waves using air guns or the like, but air guns or the like are difficult to fixedly install, and have a problem of disturbing the marine ecosystem as mentioned above. Accordingly, the present disclosure generates a stable and continuous sweep signal in a frequency range of several Hz to several hundred Hz. The vibration propagate along the seafloor and subsea strata.

In the present example, an eccentric motor that is waterproofed and pressure-proofed may be seated on the seabed and used as the seismic source 30. The eccentric motor may be operated by a battery, but since the carbon dioxide storage site usually has an offshore platform 9 as shown in FIG. 4, the eccentric motor is used with a power cable connected thereto. However, even if a separate seismic source such as the eccentric motor is not installed, when there is an offshore wind turbine (not shown) near the reservoir, the vibration generated by the wind turbine may be utilized. The wind turbine also has a fixed position and generates a stable and continuous signal with low energy, and thus may function as the fixed continuous seismic source of the present disclosure. When the wind turbine is used as the seismic source, there is an advantage in that the system may be operated very economically, similar to using the communication optical cable as a fiber optic sensor.

The seismic receiver 35 is installed close to the fixed continuous seismic source. The seismic receiver 35 receives the sweep signal generated by the seismic source 30 in the form of a direct wave transmitted through the ground, rather than a reflected wave from a stratum. The direct wave received from the seismic receiver 35 is used as a reference waveform in the sweep deconvolution processing, which will be described below, as the original sweep signal form is preserved intact. Various types of seismic receivers may be used, but in this example, a geophone is employed.

The interrogator 40 is installed on the offshore platform and is connected to the optical cables 10 and 20 laid on the seabed to implement a distributed acoustic sensing system.

The interrogator 40 is equipped with a light source 41. Laser light emitted from the light source is converted into an optical pulse through an optical modulator 42 and transmitted to the optical cables 10 and 20 through an optical circulator 43. An optical signal travels forward along the optical cables 10 and 20, but there is backscattered light that is reflected backwards due to light scattering at each point (continuously) of the optical cables through which the light passes. That is, the light propagating through the optical cables is scattered when it collides with particles smaller than the wavelength of the light due to the non-uniformity of the density of the optical cables, thereby generating a reflected signal (backscattered light) in an opposite direction. The backscattered light returning from the optical cables is guided to an optical amplifier 44 through the optical circulator 43. In the optical amplifier, the backscattered light is amplified and transmitted to a photodetector 45, and the photodetector 45 converts the backscattered light into an electrical signal. Finally, a signal conversion unit 46 converts the electrical signal (analog signal) into a digital signal.

The components of the interrogator 40 include various elements such as an amplified spontaneous emission (ASE) bandpass filter in addition to the elements described above, but since this is a widely known technology in the relevant technical field, a detailed description will be omitted.

The backscattered light is generated at all points of the optical cable and returned, but the backscattered light generated at the beginning of the optical cable arrives first and the backscattered light generated at the end arrives last. When the backscattered light returning after a single transmission of a light pulse is arranged in time sequence, the sequence corresponds to a sequence of light returning from respective points of the optical fiber from the beginning to the end. That is, the arrival time of the backscattered light is ultimately the same as a point (distance) where the backscattered light occurs in the optical cable. When a specific part of the signal detected continuously in order of time (or distance) shows an abnormal pattern different from the existing one, it may be confirmed that an external factor such as vibration, temperature change, or the like has acted on the optical cable at that point.

That is, in a normal state where there is no external factor acting on a target object, the reflected signal shows a constant pattern, but when an external influence such as vibration acts on the target object and the optical cable, the scattering size, frequency, and phase of the light change, causing the reflected signal to show a pattern different from the normal state. By detecting a reflection signal with a pattern different from the normal state, it is possible to infer that an event has occurred in the target object/optical cable. In addition, as mentioned above, since the backscattered light is detected in time sequence, when a normal pattern signal comes in first and then an abnormal pattern signal comes in at some time point, it is possible to identify at which point in the optical cable this abnormal signal has occurred.

As described above, using the DAS system, it is possible to obtain backscattered-light signals that are scattered and returned from all points of the optical cable, and since the optical cable sensor has a spatial resolution of at least 0.25 m, it has the same effect as installing vibration sensors such as geophones or hydrophones at 0.25 m intervals.

Meanwhile, when the fixed continuous seismic source 30 vibrates continuously for a certain period of time (e.g., 20 minutes), the vibration is transmitted to the optical cable in various forms through the stratum. That is, as indicated by a and c in FIG. 2, the vibration may be transmitted directly to the optical cables 10 and 20 through the stratum. In addition, the vibration is reflected when the medium changes, such as at a stratum boundary or a carbon dioxide reservoir 3, and is transmitted to the optical cables 10 and 20 in the form of a reflected wave, as indicated by b and d in FIG. 2.

The left and right sides of FIG. 3 are DAS signals obtained from the vertical optical cable 20 installed in the borehole and the horizontal optical cable 10 installed on the seafloor, respectively. The signal a directly transmitted from the seismic source 30 in the vertical optical cable 20 exhibits a downward-sloping signal shape since a signal transmission time T becomes longer as a depth h of the borehole increases, but the signal of the reflected wave b reflected from the subsea stratum exhibits an upward-sloping signal shape since the signal transmission time T becomes shorter as the depth of the optical cable 20 increases. In the horizontal optical cable 10, the signal c directly transmitted from the seismic source 30 (a point V) has a longer signal transmission time T as a distance d from the seismic source increases. Since the reflected wave d propagates upward in a concentric shape from the reflected point, the signal shape in the horizontal optical cable 10 installed on the seafloor shows a hyperbolic signal shape.

The digital signal generated in the interrogator 40 is converted into a pulse wave (impulse response) form detected by an impulsive-type seismic source and a seismic receiver in a signal conversion unit 50. In the related art, in marine seismic exploration, when seismic waves are transmitted primarily using the impulsive-type seismic source, such as an air gun, the reflected waves reflected from each stratum boundary of the seafloor are received in the form of pulse waves. When the reflected waves are received in the form of pulse waves, the boundary of the strata may be easily identified. However, a reflected wave resulting from the transmission of a low energy continuous sweep signal such as one generated by an eccentric motor is extended in time, making signal interpretation difficult. Accordingly, in the present disclosure, the sweep signal is converted into a pulse wave form using the sweep deconvolution technique in the signal conversion unit 50. Hereinafter, the converted signal is referred to as an “impulse-response converted signal.”

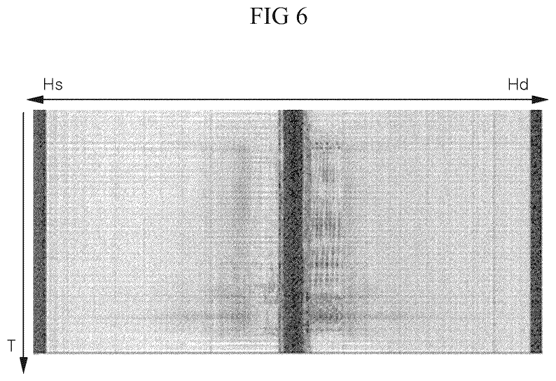

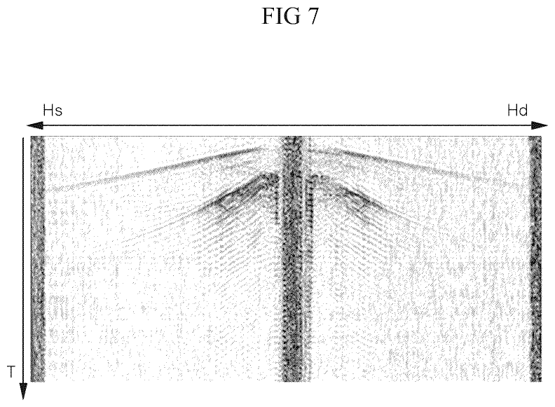

FIG. 6 shows data received by a DAS system after a sweep signal is transmitted from an eccentric motor, and FIG. 7 shows a result of converting DAS data into an impulse-response converted signal through sweep deconvolution processing. In FIGS. 6 and 7, an X-axis is a depth axis, with the center being the location of the seismic source, and the depth decreases toward the left and the depth increases toward the right. A Y-axis is the time at which a signal is recorded. In FIG. 6, a DAS signal in which a low-energy continuous sweep signal is recorded is not easy to interpret since the signal is extended in time and is not prominent, whereas in the impulse-response converted signal obtained after sweep deconvolution, the signals are clearly separated, so that interpretation is easy.

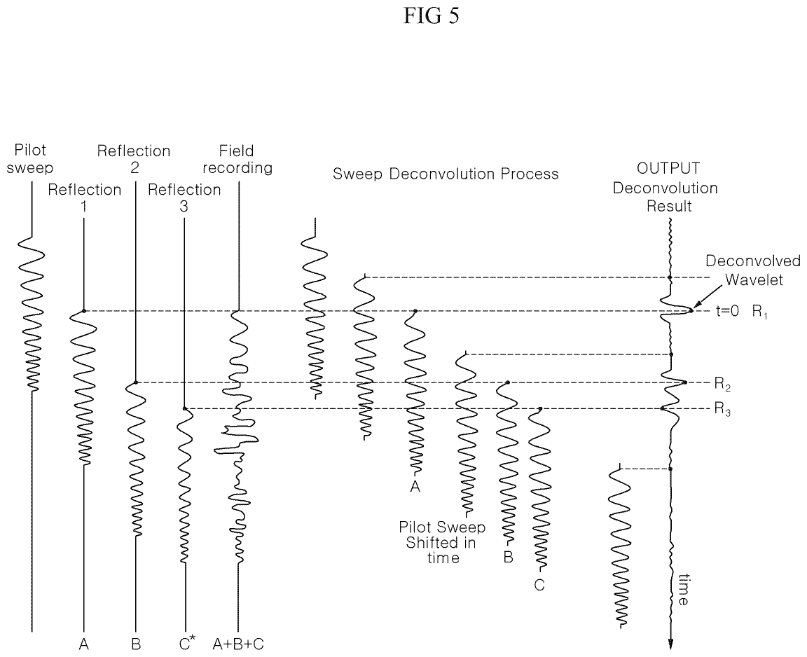

FIG. 5 briefly describes sweep deconvolution with reference to FIG. 5 to describe the concept of sweep deconvolution processing.

In FIG. 5, Pilot sweep on the left is a sweep signal generated from a continuous seismic source 30. In the vibration source, a sweep signal is generated by vibrating for several minutes, for example, and the sweep signal is directly transmitted through an underground formation to a seismic receiver 35 installed in proximity to the seismic source 30 and is received. The entire sweep signal for several minutes is recorded on the seismic receiver. In addition, the sweep signal then propagates through the stratum and is reflected at points where the medium changes, such as the boundary of the strata or the reservoir where carbon dioxide is stored, and is applied to the optical cable and recorded in the DAS signal.

In FIG. 5, the right side of the pilot sweep signal shows reflected waves (Reflection1, 2, 3) reflected by the stratum or carbon dioxide reservoir. In addition, Field recording on the right side of the reflected waves represents a signal actually received from the DAS interrogator. An actual signal received from the DAS interrogator appears as a form in which some or all of the above-mentioned reflected waves A, B, and C are overlapped over time. For example, assuming that an A stratum boundary, a B stratum boundary, and the carbon dioxide reservoir are arranged in this sequence in the depth direction from the seafloor, a 5-minute sweep signal generated from the seismic source is reflected and recorded at each of the A stratum boundary, the B stratum boundary, and a boundary of the carbon dioxide reservoir. In the sweep deconvolution processing, as shown in OUTPUT in FIG. 5, a point where the reflected wave has occurred may be detected by comparing the signal waveform of the sweep signal recorded on the seismic receiver and a signal waveform of the reflected wave with each other. In addition, when a depth difference between the A stratum boundary, the B stratum boundary, and the boundary of the carbon dioxide reservoir is not large, the reflected wave signals may overlap each other, but each reflected wave may be identified through signal processing. Looking at the OUTPUT in FIG. 5, since the impulse-response converted signal appears at the point where the reflected wave has occurred as a result of the sweep deconvolution, the point where the reflected wave has occurred may be confirmed.

In the present disclosure, when vibration is generated for several minutes using the method described above and a signal is recorded in the DAS system, the signal is recorded, through signal processing and conversion, as an impulse-response converted signal as in OUTPUT in FIG. 5. In addition, this sensing operation is repeated several times with time intervals. A signal enhancement unit 60 increases a signal-to-noise ratio by stacking a plurality of impulse-response converted signals. When signals are stacked a plurality of times, random noises do not cancel each other out and do not increase in size, but signals overlap each other and increase in size, thereby clearly distinguishing the signal from random noise.

The signal that has passed through the signal enhancement unit 60 is analyzed in a time-lapse analysis unit 70. The time-lapse analysis unit 70 detects a change in the state of the reservoir using a result of monitoring at each time interval, that is, before and after injection of carbon dioxide. Alternatively, the difference is detected from results of monitoring performed at different time points during carbon dioxide injection.

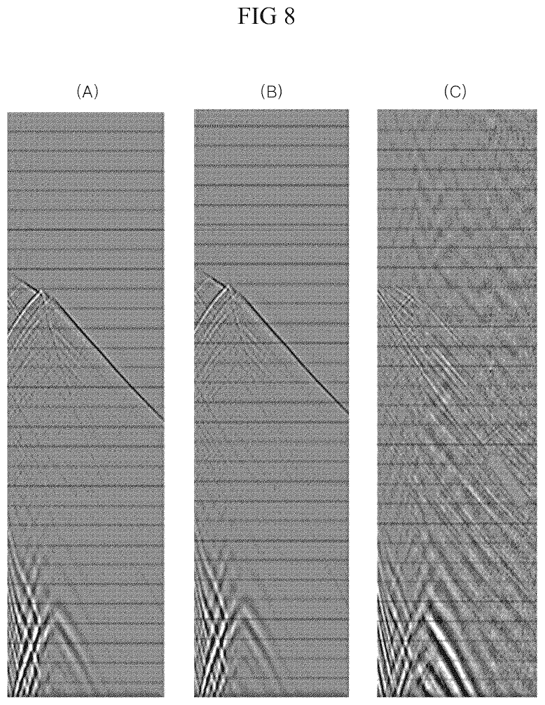

FIG. 8 is a view for describing time-lapse analysis. Referring to FIG. 8, (A) is a result of monitoring before injecting carbon dioxide, and (B) is a result after injecting carbon dioxide. A difference before and after injection is shown in (C). Looking at an arrow portion in (C), a line is drawn thickly in an upward-sloping direction, which is not recorded before injection and indicates a changed state after injection. In time-lapse analysis, as shown in FIG. 3, an upward wave in the form of an upward-sloping straight-line and a reflected wave in hyperbolic form may be derived, so that a time-lapse change is detected.

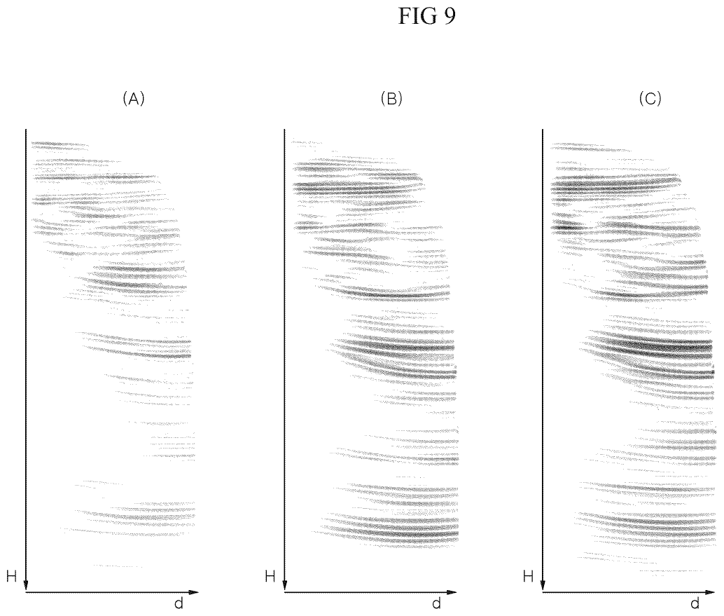

As described above, when the time-lapse analysis is completed, the Kirchhoff migration technique is used to display the stratum including the reservoir on a 2D or 3D screen as shown in FIG. 9 to improve visibility. When a signal recording form of FIG. 8 is subjected to Kirchhoff migration, it takes a form as shown in FIG. 9. In FIG. 9, (A) represents before carbon dioxide injection, (B) represents after injection, and (C) represents the difference, and the X-axis indicates the distance from the borehole, and the Y-axis indicates the depth (or time). Looking at FIG. 9, from the perspective of carbon dioxide monitoring, a plume filled with carbon dioxide in the reservoir may be confirmed before and after carbon dioxide injection.

For reference, the signal conversion unit, the signal enhancement unit, the time-lapse analysis unit, and the Kirchhoff-migration conversion at the rear end of the interrogator described above are processed by executing software on a computer.

As described above, the behavior of carbon dioxide in a subsea carbon dioxide reservoir is monitored using the DAS system. In the present disclosure, not only is the position of the seismic source fixed, but the position of the optical cable is also fixed, so that unlike conventional seismic exploration, monitoring may always be performed under constant conditions and environments, thereby improving the reliability of the analysis of monitoring results. In addition, by performing monitoring using the DAS system, the monitoring operation is not only very simple but also economical compared to an existing monitoring system using survey vessels and streamers. Accordingly, not only is very frequent monitoring possible, but further, continuous monitoring in real time is also possible during carbon dioxide injection, so that it is advantageous for identifying the behavior of carbon dioxide.

In one example of the present disclosure, an offshore wind turbine is used as a fixed continuous seismic source and a communication optical cable already installed on a carbon dioxide storage site offshore platform is used as a DAS system optical cable, thereby providing an advantage of minimizing the investment facilities for a monitoring system.

There is an advantage in that a laying operation of a optical cable is facilitated by developing a structure that is to be used when the optical cable is separately laid on the seabed, the structure being configured to prevent the optical cable from being broken during the laying process and to allow the optical fiber to be accurately seated on the seafloor.

In the present disclosure, the behavior of carbon dioxide in a subsea carbon dioxide reservoir is monitored using a distributed acoustic sensing (DAS) system.

In the present disclosure, not only is the position of a seismic source fixed, but the position of an optical cable is also fixed, so that unlike conventional marine seismic exploration, monitoring can always be performed under constant conditions and environments, thereby improving the reliability of the analysis of monitoring results.

In addition, by performing monitoring using the DAS system, monitoring is not only very simple but also economical compared to an existing monitoring system using survey vessels and streamers. This not only allows monitoring to be performed in short cycles, but also allows continuous, real-time monitoring during carbon dioxide injection, thereby providing an advantage in understanding carbon dioxide behavior in a reservoir.

In one example of the present disclosure, an offshore wind turbine is used as a fixed continuous seismic source and a communication optical cable already installed on a carbon dioxide storage site offshore platform is used as a DAS system optical cable, thereby providing an advantage of minimizing the investment facilities for a monitoring system.

There is an advantage in that a laying operation of an optical cable is facilitated by developing a structure that is to be used when the optical cable is separately laid on the seabed, the structure being configured to prevent the optical cable from being broken during the laying process and to allow the optical fiber to be accurately seated on the seafloor.

The scope of the present disclosure is not limited by the examples and descriptions specifically described so far. Furthermore, it is stated once more that the scope of the present disclosure should not be construed to be limited by an obvious change or a substitution in the field to which the present disclosure pertains.

What is claimed is:

1. An underground carbon dioxide monitoring system using a subsea optical cable, comprising:
an optical cable laid on a seafloor of a carbon dioxide subsea storage site;
a fixed continuous seismic source configured to apply continuous vibration for a predetermined period of time at a fixed position in the subsea storage site to generate a sweep signal;
a seismic receiver installed close to the fixed continuous seismic source and configured to directly receive the sweep signal that is not reflected by a stratum;
an interrogator including a light source configured to irradiate the optical cable with laser light, a photodetector configured to receive a backscattered-light signal that is returned from each point of the optical cable by the laser light emitted from the light source, and a signal processing unit configured to process the backscattered light; and
a signal conversion unit configured to convert the backscattered-light signal received from the interrogator into an impulse-response converted signal to be received by an impulse-type seismic source and the seismic receiver.

2. The underground carbon dioxide monitoring system of claim 1, wherein the signal conversion unit generates the impulse-response converted signal to be received using the impulse-type seismic source and the seismic receiver from the backscattered-light signal through sweep deconvolution processing of comparing the backscattered-light signal processed by a signal processing unit of the interrogator and the sweep signal received by the seismic receiver with each other.

3. The underground carbon dioxide monitoring system of claim 1, wherein a strength reinforcement wire capable of withstanding tension is secured together with the optical cable to prevent the optical cable from breaking when the optical cable is laid on the seafloor from a sea surface.

4. The underground carbon dioxide monitoring system of claim 3, further comprising a plurality of weights coupled to the strength reinforcement wire or the optical cable for the optical cable to be seated on the seafloor.

5. The underground carbon dioxide monitoring system of claim 1, further comprising a signal enhancement unit configured to generate a plurality of impulse-response converted signals by performing monitoring on the optical cable at time intervals, and then increase a signal-to-noise ratio by stacking the plurality of impulse-response converted signals.

6. The underground carbon dioxide monitoring system of claim 1, further comprising a time-lapse analysis unit configured to generate the impulse-response converted signals at different time points before and after carbon dioxide injection or during carbon dioxide injection, and then perform time-lapse analysis to derive differences between the impulse-response converted signals at respective time points.

7. The underground carbon dioxide monitoring system of claim 6, wherein the time-lapse analysis unit separates a signal in the form of a reflected wave from the impulse-response converted signals at different time points and identifies a change in a reservoir.

8. The underground carbon dioxide monitoring system of claim 6, wherein a borehole is formed in the reservoir,
a vertical optical cable disposed vertically on a wall surface of the borehole and connected to the interrogator is installed, and
the time-lapse analysis unit separates a reflected wave signal having an upward-sloping form from the impulse-response converted signals that are acquired and converted from the vertical optical cable at respective different time points and identifies a change in the reservoir.

9. The underground carbon dioxide monitoring system of claim 1, wherein the fixed continuous seismic source is an offshore wind turbine.

10. The underground carbon dioxide monitoring system of claim 1, wherein the optical cable is a communication optical cable that is pre-installed on the seafloor.
